(19) United States
(12) Patent Application Publication
(10) Pub. No.: US 2014/0249719 A1
(43) Pub. Date: Sep. 4, 2014

(54) METHOD FOR AUTOMATICALLY CONTROLLING THE ELECTRIC STEERING LOCK FOR THE STEERING COLUMN OF A MOTOR VEHICLE

(71) Applicants: Winfried Gauch, Erdweg (DE); Emmanuel Bollinger, Erdweg (DE)

(72) Inventors: Winfried Gauch, Erdweg (DE); Emmanuel Bollinger, Erdweg (DE)

(73) Assignees: VALEO SECURITE HABITACLE, Creteil (FR); VALEO SICHERHEITSSYSTEME GMBH, Erdweg (DE)

(21) Appl. No.: 13/979,344

(22) PCT Filed: Jan. 11, 2012
(86) PCT No.: PCT/EP2012/050369

§ 371 Date: Jan. 30, 2014

(30) Foreign Application Priority Data
Jan. 13, 2011 (FR) FR1100116

(51) Int. Cl. B62D 5/04

(52) U.S. Cl. CPC B62D 5/0475
USPC 701/41

(57) ABSTRACT

The invention relates to a method for controlling the electric steering lock (1) for the steering column (2) of a motor vehicle, consisting in effecting an automatic predetermined rotation of the steering column (2), locking the steering lock (2), when the engine (4) of this vehicle is stopped.

The invention relates to a method for automatically controlling the electric steering lock for the steering column of a motor vehicle.

Conventionally, an electric steering lock for a steering column comprises a bolt that can be actuated and is designed to be engaged in one of the recesses provided on the column during locking and to be removed from this recess during unlocking. As an example, such an arrangement is described in patent document EP 1 029 755.

Furthermore, these days, the rotation of the steering column by means of the steering wheel is assisted by means of electric power steering, making the maneuvering of the vehicle lighter.

Currently, when his motor vehicle is stopped, the driver must make a slight wheel rotation of the steering wheel to ensure that the steering-column lock is fully locked after the engine is stopped. This allows the full engagement of the bolt of the steering-column lock in one of its recesses of the column, when it is placed in abutment on the side of this recess. Conventionally, the driver must take care to turn the steering wheel until there is a click indicating the full locking and immobilization of the steering wheel. Then the steering lock fulfils its function fully by preventing the steering wheel and the steered wheels from turning.

The object of the invention is to remove the need for this manual intervention of the driver, which may be unintentionally forgotten when the vehicle is stopped and which is of a particularly troublesome recurrent and irregular character.

To do this, the invention proposes a method for automatically controlling the steering lock for the steering column of a motor vehicle, consisting in carrying out a determined automatic rotation of the steering column, for locking the steering lock, when the engine of this vehicle is stopped.

According to a preferred embodiment, said rotation of the steering column of the vehicle is preceded by a determination of the position of the bolt of the steering-column lock and said rotation is carried out when it is determined that the bolt is not engaged in a recess of the column.

Very advantageously, the motor vehicle comprising electric power steering, said locking rotation is carried out by means of this electric power steering. The invention can therefore be put in place without additional control arrangement.

Furthermore, in certain configurations, for example when the wheels are butting against a sidewalk, and when the driver has taken care to carry out this action of turning the steering wheel until the bolt is fully engaged in one of its recesses of the column, it may be difficult for the electric steering lock to extract the bolt from this recess, when the driver starts the vehicle, because of the pressure exerted on the bolt by means of the wheels and of the steering column. In this case, usually, the driver is warned that he must carry out a slight rotation of the steering wheel in order to help the release of the bolt.

Advantageously, the method according to the invention also consists in carrying out a determined inverse automatic rotation of the steering column, called unlocking of the steering lock, after the engine of this vehicle is started.

Preferably, said unlocking rotation of the steering lock is preceded by a determination of the position of the bolt of the steering-column lock and said rotation is carried out when it is determined that the bolt is in a recess of the column, after a rotation force on the steering wheel.

Very advantageously, the motor vehicle comprising electric power steering, said unlocking rotation is carried out by means of this electric power steering. The invention can therefore be put in place without additional control arrangement.

The invention is described below in greater detail with the aid of figures illustrating a preferred embodiment of the invention.

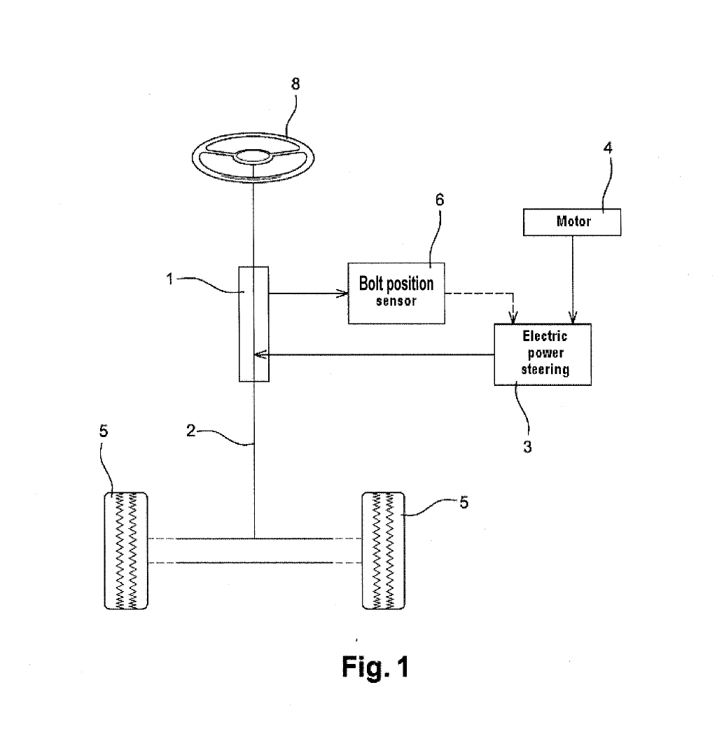

FIG. 1 illustrates schematically the method according to the invention.

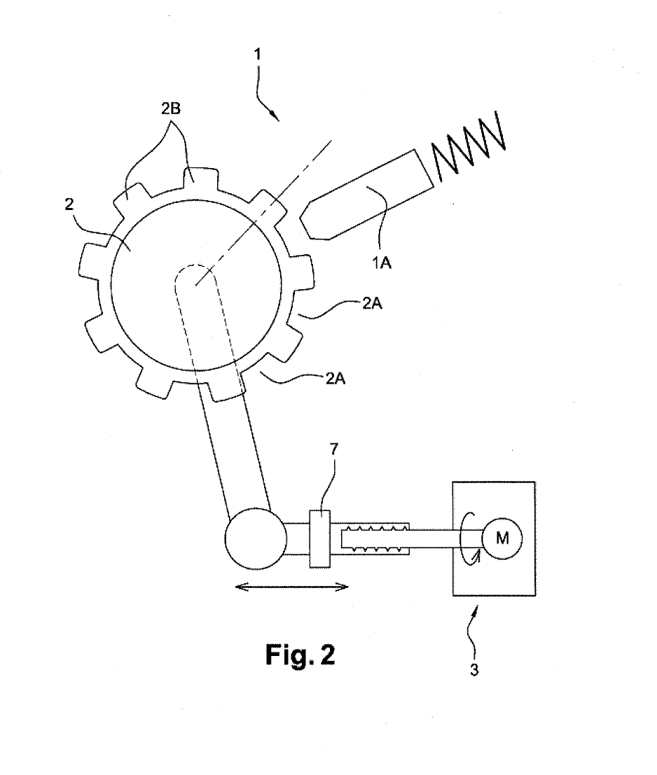

FIG. 2 is a detailed schematic view of the steering column.

As illustrated in FIG. 1, the method for automatically controlling the steering lock 1 for the steering column 2 of a motor vehicle comprising electric power steering 3 consists, according to the invention, in carrying out a determined automatic rotation of the steering column 2 connecting the steering wheel 8 and the steered wheels 5 by means of this electric power steering 3 when the engine 4 of this vehicle is stopped. This rotation is a rotation for locking the steering lock.

Preferably, this rotation of the steering column 2 of the vehicle is preceded by a determination of the position of the bolt of the steering-column lock 1 by means of a sensor 6 and the rotation is carried out when it is determined that the bolt is not engaged in a recess of the column 1.

The same equipment can be used to apply a method, according to the invention, also consisting in carrying out a determined inverse automatic rotation of the steering column 2, called unlocking of the steering lock, by means of this electric power steering 3 after the engine 4 of this vehicle is started.

Preferably, this rotation of the steering column 2 of the vehicle is preceded by a determination of the position of the bolt of the steering-column lock 1 and this rotation is carried out when it is determined that the bolt is in a recess of the column 2, after a rotation force on the steering wheel 8. Thus the disengagement of the bolt is assisted, when it is found that the manual rotation of the steering wheel is difficult, in certain configurations, for example when the wheels are butting against a sidewalk.

FIG. 2 shows schematically the steering column 2 provided with recesses 2A for the bolt 1A of the steering lock 1. The steering column 2 is connected to the power steering 3 which can be an electric motor wherein the rotary movement of its shaft is transformed into rotation of the column 2 by an arrangement of worm and connecting rod. This power steering 3 is driven by means of a torque sensor 7 of the steering wheel and of the column.

The determined automatic rotation of the steering column 2 according to the method for locking the steering lock according to the invention is therefore determined as a function of the configuration of the recesses 2A of the column, more precisely of the angular width of the peaks 2B separating them, in order to ensure a full engagement of the bolt 1A in a recess when it is positioned in abutment against the adjacent peak 2B of this recess 2A. In practice, it corresponds to a few degrees of rotation of the steering column 2.

The determined automatic rotation of the steering column 2 according to the method for unlocking the steering lock according to the invention is for its part designed to reduce the rotational torque that opposes the disengagement of the bolt 1A by the steering lock 1 and is inverse to the rotation for locking the steering lock. By virtue of the torque sensor 7, it is preferably applied after a rotation force on the steering wheel 8 demonstrating a difficulty of manual unlocking.

1. A method for controlling the electric steering lock for the steering column of a motor vehicle, comprising:
carrying out a determined automatic rotation of the steering column, for locking the steering lock, when an engine of the vehicle is stopped.

2. The method as claimed in claim 1, wherein said rotation of the steering column of the vehicle is preceded by a determination of the position of a bolt of the steering-column lock and wherein said rotation is carried out when a determination is made that the bolt is not engaged in a recess of the column.

3. The method as claimed in claim 1, wherein said rotation for locking the steering lock is determined as a function of the angular width of the peaks separating the recesses of the column.

4. The method as claimed in claim 1, the motor vehicle comprising electric power steering, wherein said locking rotation is carried out by means of this electric power steering.

5. The method as claimed in claim 2, further comprising carrying out a determined inverse automatic rotation of the steering column, called unlocking of the steering lock, after the engine of the vehicle is started.

6. The method as claimed in claim 5, wherein said unlocking rotation of the vehicle steering lock is preceded by a determination of the position of the bolt of the steering-column lock and wherein the rotation is carried out when a determination is made that the bolt is in a recess of the column, after a rotation force on the steering wheel.

7. The method as claimed in claim 5, the motor vehicle comprising electric power steering, wherein said unlocking rotation is carried out by means of this electric power steering.
